(19) United States
(12) Patent Application Publication
(10) Pub. No.: US 2009/0263777 A1
(43) Pub. Date: Oct. 22, 2009

(54) Immersive interactive environment for asynchronous learning and entertainment

(76) Inventor: Arthur J. Kohn, Portland, OR (US)

Correspondence Address: KOLISCH HARTWELL, P.C., 200 PACIFIC BUILDING, 520 SW YAMHILL STREET, PORTLAND, OR, 97204, US

(21) Appl. No.: 12/313,420

(22) Filed: Nov. 19, 2008

Related U.S. Application Data
(60) Provisional application No. 61/003,564, filed on Nov. 19, 2007.

(51) Int. Cl. G09B 7/00

(52) U.S. Cl. 434/350

(57) ABSTRACT

The present immersive interactive environment for asynchronous learning and entertainment enables customization a lesson embodied in at least one lesson data file residing on a computing device. This is accomplished by providing a lesson data file-editing program embodied in at least one sequence of computer executable instructions to an instructor by allowing the instructor to execute the editing program via a computing device in order to customize a lesson data file. The instructor is also provided with at least one general lesson data file via said computing device. The instructor is thus able to customize the general lesson data file via said editing program to create a customized lesson, the customized lesson being embodied in at least one customized lesson data file residing on said computing device. A student will thus be capable of accessing said at least one customized lesson data file via a lesson presentation program embodied in at least one sequence of computer executable instructions and thereby able to perceive the customized lesson.

### CROSS-REFERENCE TO RELATED APPLICATIONS

This application claims priority to U.S. provisional patent application Ser. No. 61/003,564 filed on Nov. 19, 2007, the complete disclosure of which is incorporated herein by reference.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

### Field of the Invention

This invention provides systems and methods for developing and delivering multi-featured, life-like learning in a virtual 3D environment.

### BRIEF SUMMARY OF THE INVENTION

Advances in technology and network communication have dramatically changed the way we can deliver education. Electronic learning (or e-Learning) refers to a form of education where the principle medium of instruction is computer technology. E-learning has become a powerful tool in all areas of education and training including K-12 education, college and university training, continuing education and corporate training. The worldwide e-learning industry is estimated to be worth over 38 billion dollars.

E-learning can be delivered using desktop and laptop computers as well as other networked devices such as personal digital assistants (PDAS) and Web-enabled cell phones. Indeed, with the advent of networked communications physical distance is no longer a barrier to education. Students and instructors are able to exchange information, classroom lectures, homework assignments, text, question and answer interaction sessions, and other related information to effect a traditional learning or educational experience regardless of physical location.

During the last 15 years, e-Learning has seen the growth of two related technologies: Learning Management Systems and Lecture Presentation software.

A Learning Management System (or LMS) is a software package that enables the management and delivery of online content to learners. For example, U.S. Pat. No. 6,988,138 discloses an online education system in which a course-based system allows users access to a plurality of online courses and a collection of roles within the system including student, teacher, and administrative roles. LMS provide three types of functionality: course management, pedagogical tools, and content development.

The major capacity of LMS is to enable teachers and administrators to manage educational courses especially by supporting course administration. Typically, an LMS allows for learner registration, delivery of learning activities, competency management, skills-gap analysis, certifications, and resource allocation. Most learning management systems also provide a collection of communication tools that enhance learning. These tools include Simulations, collaborative exploration, synchronous and asynchronous discussions, blogs, RSS syndication and electronic voting systems. Learning management systems also usually include templates for the creation and delivery of content. Authors and teachers fill in templates and create standardized “pages” of content. For example, a template-based page of content might include text, a picture or animation, and a brief drag and drop learning experience. These content pages also link to additional resources, including reading materials and outside resources in libraries and on the Internet.

LMSs have become popular because they can replace fragmented training programs with a systematic means of delivering information and assessing performance levels throughout the organization. In the area of higher education, administrators are discovering that distance education can significantly reduce the cost of delivering-a curriculum.

The problem with these learning management systems, however, is that their focus in almost entirely on management with no innovation directed toward learning. The interface is largely text driven, and the content delivered within these learning modules is typically bland, text-laden, and pedagogically ineffective (FIG. 1A). There are two reasons these tools have been so ineffective. First, the shortcomings result from migrating prior communication techniques onto a new technology. For example, when television became popular, early producers tried to simply migrate radio dramas onto the screen. These programs were dull and not very popular. It took several years before they producers discovered how to make use the full capability of this visual medium. Likewise, current learning modules are based on text-laden books and simply migrate these words onto the computer screen. Likewise, current learning packages migrated from paper and pencil tradition and rely on text for communication and use the “page” as their organizing principle. Students register on a form, receive their content as screen text, and complete word-based assessments.

The second reason that learning modules are so ineffective is that they seek to conform to a set of limiting standards known as SCORM (Sharable Content Object Reference Model). SCORM defines communications between client side content and a host system, and defines the ways that text-based objects must be structured. While these standards make it possible to share learning objects across applications, these standards have limited innovation and the use of more creative learning tools.

Thus, what is needed are tools which allow authors and teachers to create on-line learning modules that are more flexible, engaging, and effective.

Efforts have also been made to, in effect, digitize the traditional lecture experience and make it available to students to students anytime, anywhere. For example, U.S. patent application Ser. No. 10/371,537 discloses an online education system in which synchronous multi-media learning is delivered. The system employs high quality, low latency audio/video feeds over a multicast network as well as an interactive slideshow that allows annotations to be added by both the presenter and lecture participants. It also provides a question management feature that allows participants to submit questions and receive answers during the lecture or afterwards. Similar products (U.S. patent application Ser. Nos. 11/457,802 and 10/325,869) have added additional features such as synchronized slide shows, shared white boards, moderated Q&A sessions, managed registration, attendance, student tracking, polling and the ability to record a meeting playback at a later time.

These on-line lecture tools have become popular because they are consistent with well-established teacher-student models of training. People have evolved to learn from one another, and an inspired lecturer can engender effective learning and recall. Furthermore, these lessons can provide a cost-effective means of training and credentialing large numbers of students and employees. Developers have optimized these tools and customers can now delivery synchronous presentations. In these presentations, teachers and students are on-line at the same time and they are able to make use of powerful communication tools including chat, white boards, and surveys and attendance features.

That said, many customers dislike synchronous meetings. It is difficult to find convenient times for synchronous meetings and the pace of these sessions is set by the instructor and students need to keep up as best they can. As a result, many customers prefer to deliver lessons asynchronously, and that can be viewed anytime, anywhere.

To accomplish this, existing lecture tools allow users to record lectures and then replay them at a later date. Unfortunately, products that present these “prerecorded lessons” have significant deficiencies.

For example, prerecorded lessons are non-adaptive and lack the ability to customize themselves to the needs of individual students. Once a lesson has been created, it provides a fixed presentation that lacks the ability to self-adapt or to change its content as a result of student interest or abilities. Furthermore, the lessons are fixed units and individual teachers or moderators or unable to customize them.

Existing tools are constrained to an interface where a plurality of functions assigned to discrete screen areas. For example, videos are presented in “the video window” and classmates are represented in a list (FIG. 1B). Likewise, the slide show, transcript and communication tools are each presented in discrete areas of the screen. This “video in its box” approach is inconsistent with the sense that a student is working within an immersive 3-dimensional learning environment.

Existing tools do not allow for real-time note taking. While some programs provide transcripts, they do not allow for real-time annotation and student is unable to save and print comprehensive transcripts which capture all of the media elements from the presentation.

Prerecorded lessons are unable to provide instant answers to student questions. Their navigational options are limited to students using a scrubber bar or clicking on an outline. Finally, these existing tools provide little sense of community. When these tools are used non-synchronously, the sense of “social learning” is lost.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1A illustrates a typical Learning Management System.

FIG. 1B illustrates a typical Live Lecture tool.

FIG. 2 illustrates a Quad section of an embodiment of the present immersive interactive environment.

FIG. 3 illustrates features available a lecture hall section of an embodiment of the present immersive interactive environment.

FIG. 4 illustrates functionality of a dynamic transcript tool.

FIG. 5 illustrates the printable transcript page.

FIG. 6 illustrates functionality of the navigable outline.

FIG. 7a illustrates how the program accepts and responds to student questions.

FIG. 7b shows alternative layout and additional features of the lecture hall environment.

FIG. 8 provides an example of a learning link activity.

FIG. 9 shows a Verbal Survey type of Learning Link.

FIG. 10 illustrates a virtual student asking a question.

FIG. 11 illustrates functionality in the recitation forum room.

FIG. 12 shows functionality with the Tutor's Office.

FIG. 13 shows the author's course selection page.

FIG. 14 shows the LessonMaker environment where authors create lessons.

FIG. 15 shows the OutlineMaker tool where authors embed timecode into the outline.

FIG. 16 shows the TranscriptMaker and the Definition tool.

FIG. 17 shows the LearningLinkMaker tool.

FIG. 18 shows the Teacher's administrative interface.

FIG. 19 shows a flowchart depicting an aspect of a preferred embodiment's standard operational flow.

FIG. 20 illustrates a flow chart of an aspect of a preferred embodiment's time-based polling system.

FIG. 21 illustrates a flow chart of an aspect of a preferred embodiment's transcript functionality.

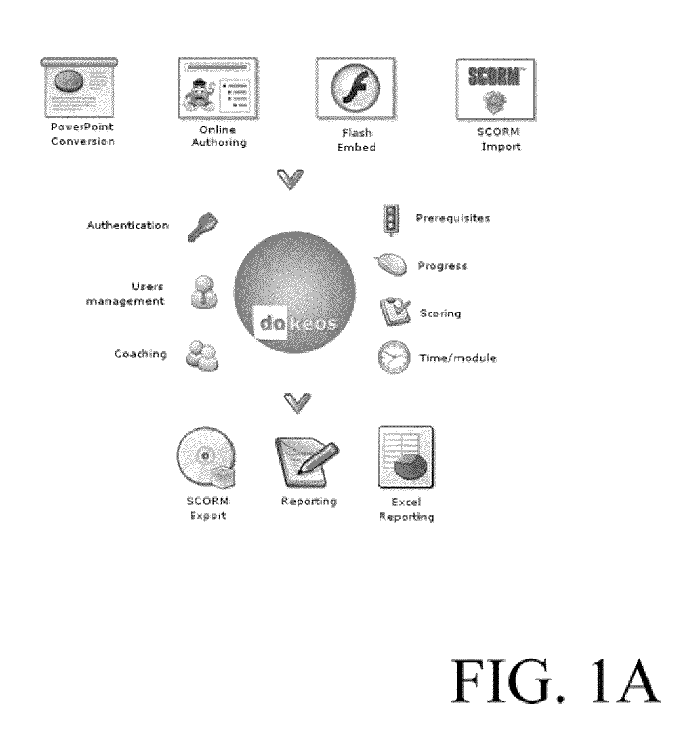

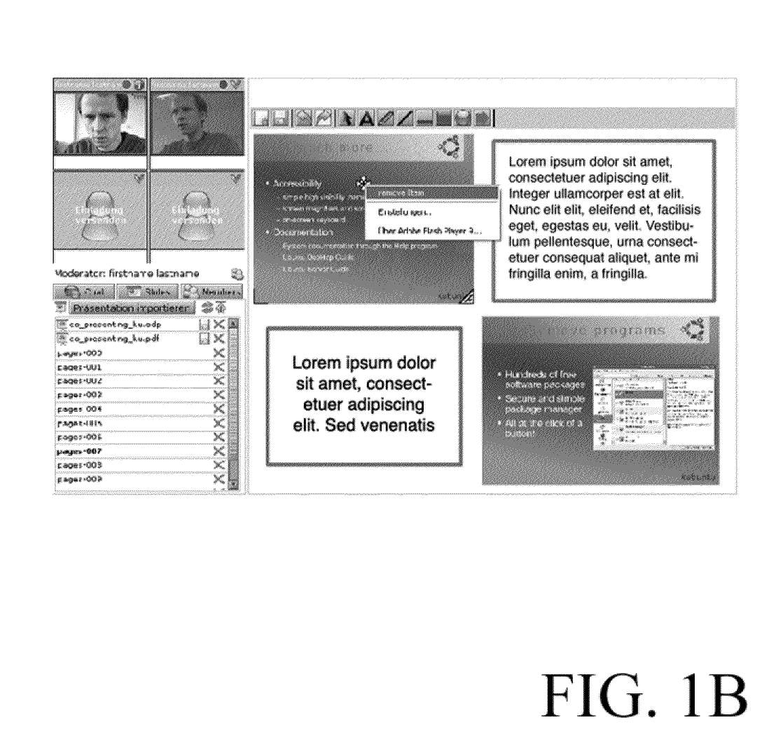

### DETAILED DESCRIPTION OF PREFERRED EMBODIMENT

A non-exclusive embodiment of the present immersive interactive environment for asynchronous learning and entertainment includes a powerful authoring tool that creates asynchronous life-like learning in an immersive 3D environment. The environment consists of a series of rooms and each room contains a wealth of interactive tools. In one embodiment, a teacher walks into a classroom and begins to speak; the on-screen audience moves about, asks questions, and interacts with the teacher. Clocks tick, virtual students enter and exit, and the lecturer interrupts himself to answer questions, survey students, provide interactive exercises, and collect best practices. And from time to time, the immersive environment changes so as to be viewed from another angle. This simulates the feel of multi-camera production and further enhances the sense of immersion. The authoring tool easily creates this immersive environment through a combination of timelines and templates that direct combinations of media elements into any area of the active room.

Lessons created in accordance with a preferred embodiment accommodate themselves to student interests on-the-fly. For example, if an interactive survey indicates that the student is shy, then the tool might branch and present a particular collection of lesson and interaction. If the student is more outgoing, the program presents a different collection. These conditional technologies can also monitor student progress and pace the presentation to the student's ability to comprehend and learn.

Individual instructors are able to customize any of the premade lessons such that their instance of the lesson is consistent with their own inclinations. For example, in a parenting class, a teacher can add a reference or remove an objectionable activity.

An alternate, non-exclusive embodiment contains a set of useful student tools. For example, the transcript presenter is synchronized with the lecturer and students and can both highlight and annotate the transcript in real time. Furthermore, the transcript is clickable and allows students to move instantly to the corresponding area of the lesson. Students have the option to ask questions and the embodiment provides uses text matching to provide instant answers. Finally, LearningLinks are intermittent pedagogical moments that enhance learning using proven pedagogical techniques. The learning links can be used to establish databases of best practices and student inclinations.

The system and method of providing personalized online education will now be explained with reference to attached figures without being limited thereto.

The system and method providing more effective teaching and learning online can be run on now well-known computer systems and communication means that are used for online education. In one embodiment, a user installs a software version of the system onto an internet server system and delivers it to client devices using any desired communication device or devices. For example, desktop computers, laptop computers, and handheld devices such as PDA's and web-enabled cell phones.

A student may log in to the enhanced education program (hereinafter “program”) to connect with the computer system running the program. The student may be prompted for a username and password. The program submits the student's information to a user database. If the login information is correct, the user is allowed to proceed. If not, the user is directed either to enter a username and password again or to subscribe to the program.

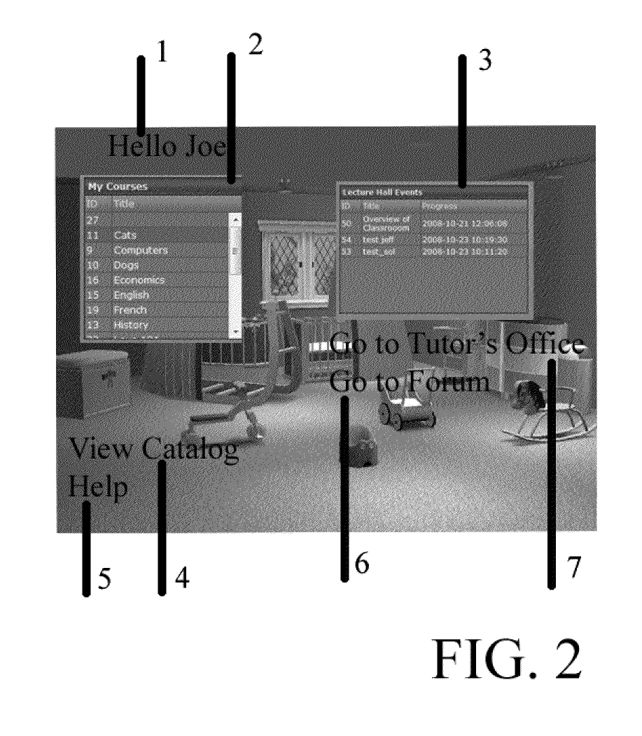

Referring to FIG. 2, the student is then directed to a Quad which serves as the home page of the program. The student may be acknowledged personally by a Greeting 1. The student is presented with the overall options for the program on this page, which may include a list of currently enrolled course 2, a syllabus for the currently selected course 3, a view catalog button 4, a help Button 5, and links to move to other rooms including a recitation forum 6, and a tutor's office 7.

If the student elects to view a lecture from the syllabus of the currently selected course, he proceeds to a lecture hall environment.

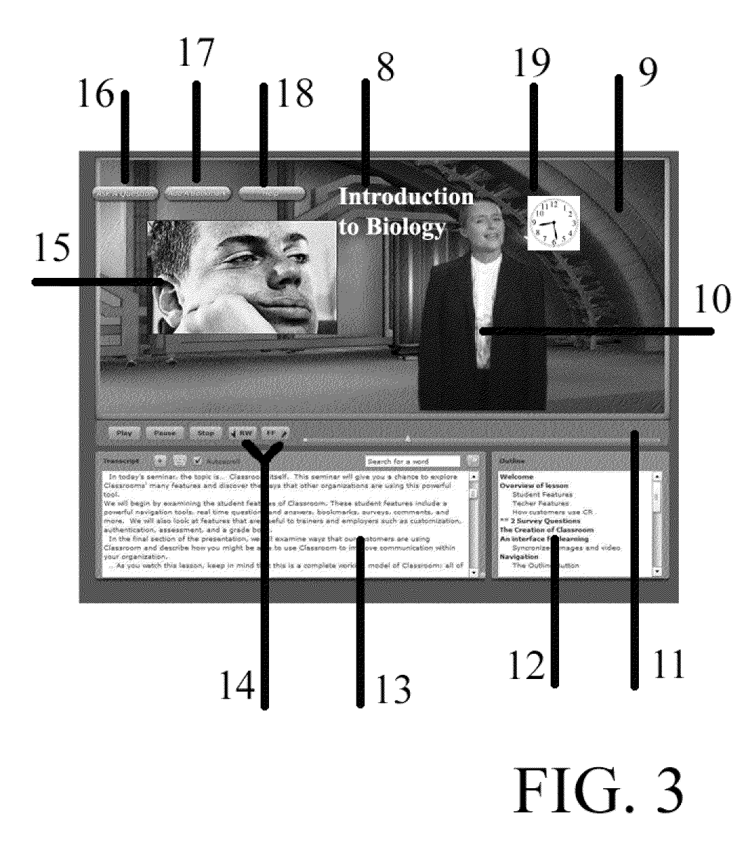

FIG. 3 shows a sample moment within an example lecture hall environment. This screen image presents the name of the present course 8, a background image that produces a sense of place and environment 9. The environment image, along with the videos and objects, intermediately change so as to be viewed from another angle. This seamless adjustment simulates the feel of multi-camera production and further enhances the sense of immersion.

After a few moments, a video instructor 10 enters the screen and presents a lesson. The host provides a real-time lesson, and enters and exits the screen intermittently throughout the lesson. A control bar 11 includes a scrubber bar along with play, pause, and stop buttons, allows the student to conveniently pause and navigate throughout the lesson. The control bar 11 also includes a “jump backward” and “jump forward” buttons 14. Clicking these buttons allows the user to instantly jump backward or jump forward ten seconds. An outline 12 is clickable and allows the student to quickly jump to a new area of the presentation. It is also customizable and students can add bookmarks to it by clinking on an “Add a bookmark” button 17, as is discussed below. An “Ask a Question” button 16 permits a student to pause the presentation to ask a question in a manner described in more detail below. A dynamic transcript 13 may also be present and is also described in more detail below. A help button 18 launches a window which contains helpful, context sensitive information.

Embodiments of the present system are not limited to the graphical layout shown in the figures. Any object may be placed in any area of the environment as desired by the instructor. Additionally, executable files and animations 19 can also be embedded for presentation.

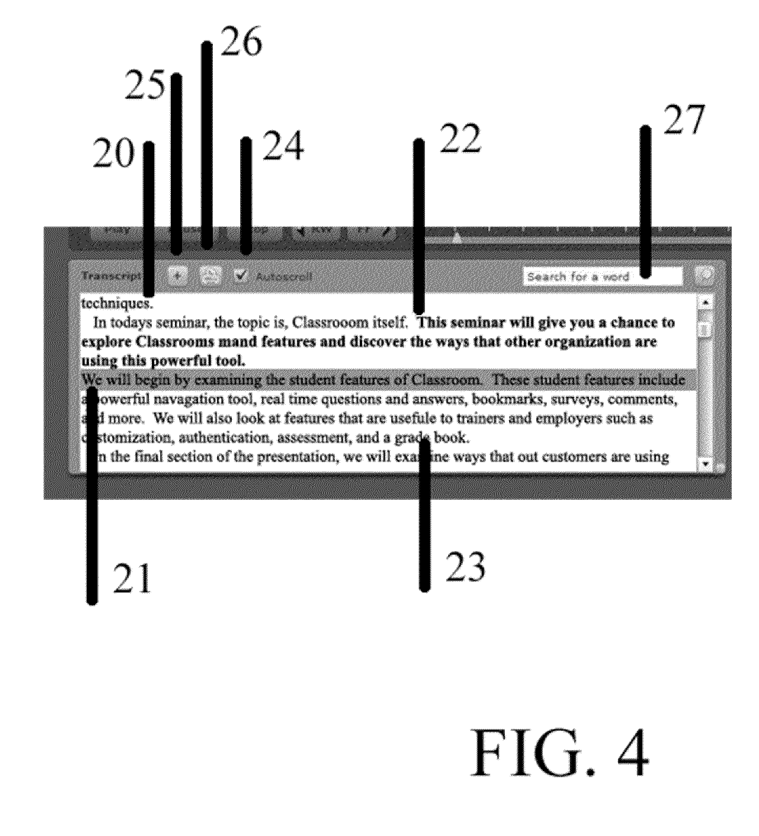

Referring to FIG. 4 the dynamic transcript tool provides the student with the text 20 of the audible portion of the presentation. The text 20 scrolls dynamically such that the words that are being spoken by the teacher are continually centered within the visual transcript window. The auto-highlighter feature 21 highlights the block of text that is currently being spoken by the on-screen presenter. The student can also add custom highlighting over a block of text at any time during the presentation 22. They can also use the transcript as a navigational tool. When they click anywhere on the transcript the presentation automatically jumps to that area of the presentation 23.

Additional features of the dynamic transcript tool are the auto-scroll radio button 24, which switches auto scrolling on and off; the comment button 25, which interrupts the presentation and allows the student to write a comment which is added to the current moment of the transcript; the print transcript button 26, which launches a print custom transcript page; and a search tool 27, which allows the student to search for any word. When a matching word is found, the transcript and the lesson automatically jump to that moment of the lesson.

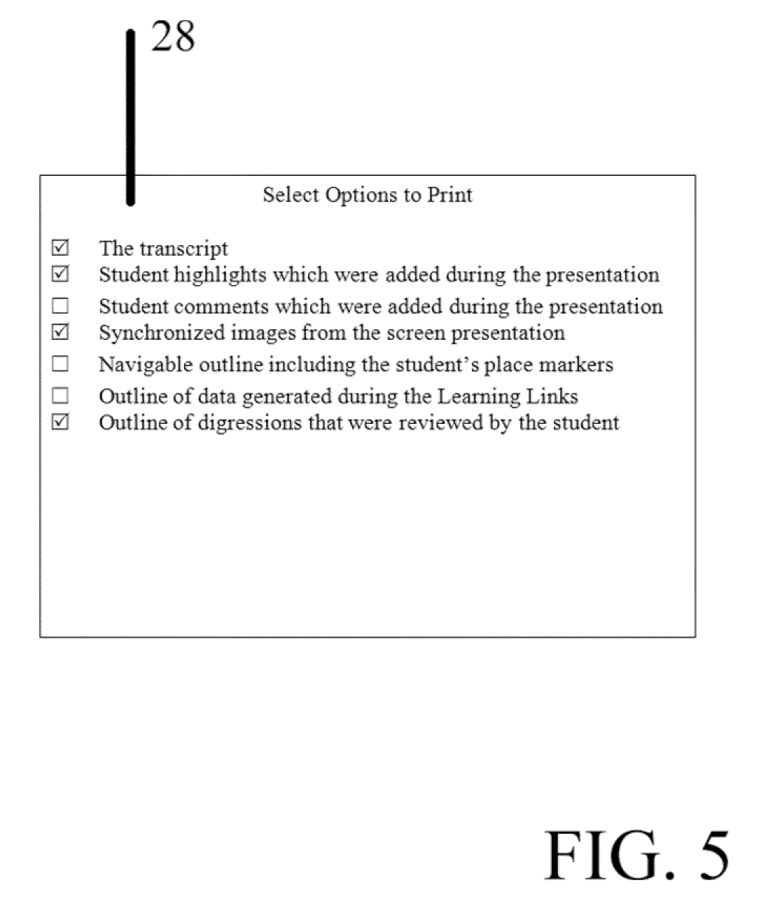

FIG. 5 illustrates a print custom transcript page. By checking the radio buttons, student's can select which options to include in the printable transcript.

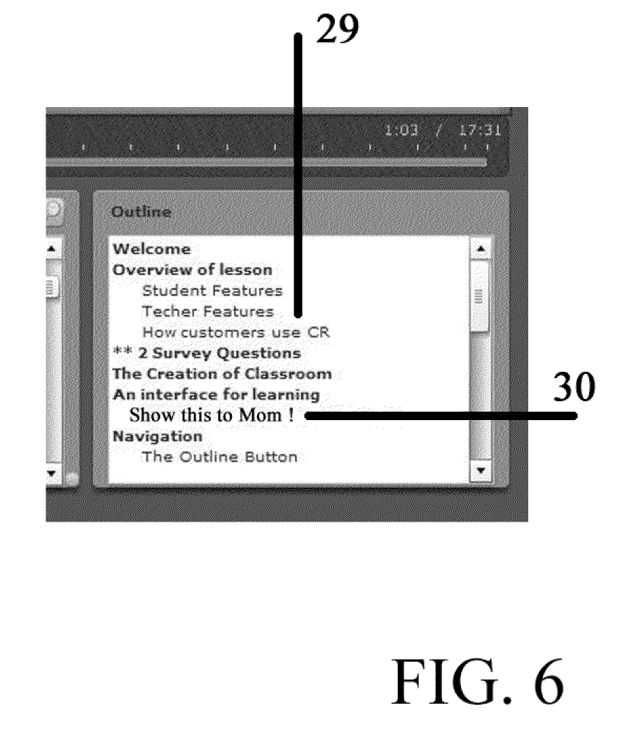

FIG. 6 shows the navigable outline. The student can use the outline as a navigational tool. If they click on any of the text 29, the lesson automatically jumps to that moment of the lesson. If the student adds a custom comment using the Add a bookmark button 17 (FIG. 3) the bookmark is added to the Outline in a unique format 30.

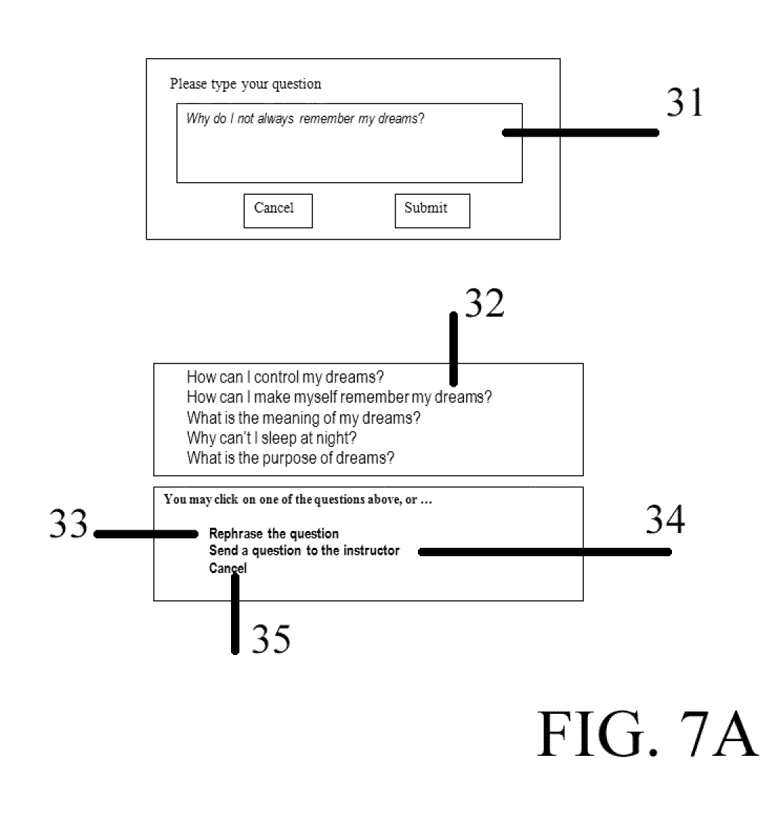

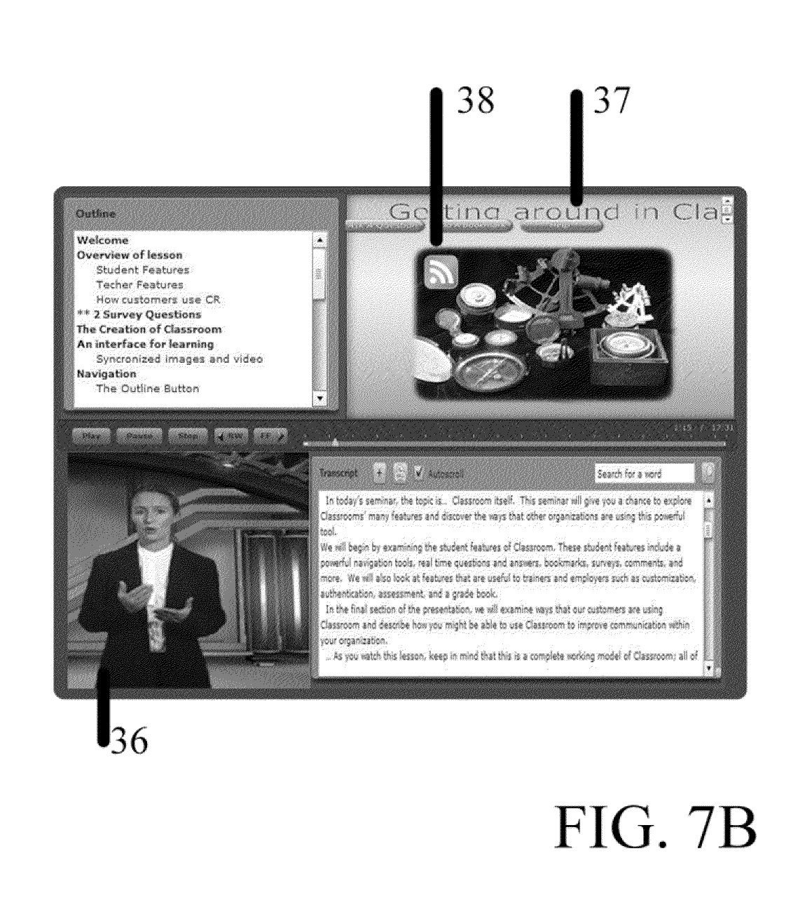

FIG. 7a illustrates how a preferred embodiment responds to student questions. When the student clicks the “Ask a Question” button 16 (FIG. 3), the lesson is paused and a text entry box 31 is opened. When the question is submitted, the program text-matches the question to a database of previously asked questions and provides student with a list of the five closest matches 32. The student may click on one of the matched questions and receive an immediate response. Alternatively, they can rephrase the question and submit it for text matching 33, submit a question to their teacher 34, or cancel the operation 35. Note that all new question and answer combinations are added to the database.

FIG. 7b shows another sample moment in the lecture hall. This moment illustrates the flexibility of the screen layout. Any screen element can be presented in unique configurations anywhere on the page 36. The screen may also contain a text scroller 37, that provides brief summary statements and a real simple syndication (RSS) based display 38 that streams dynamically updated information to the student.

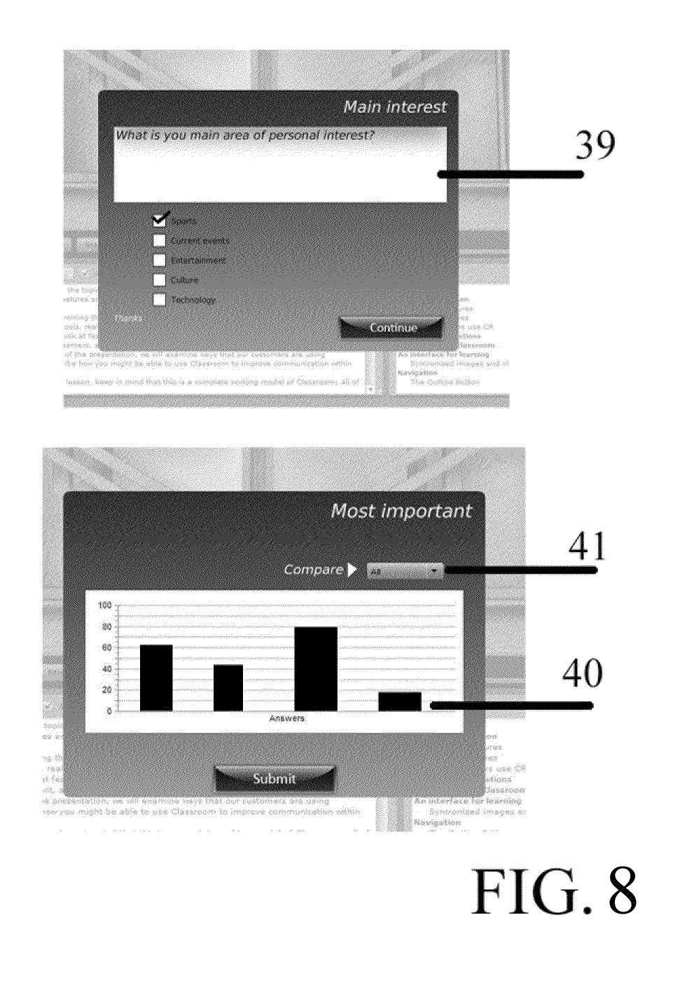

FIG. 8 shows an example of a learning link activity 39. These learning links are presented at about five minute intervals and include surveys, interviews, and quiz questions that enhance student engagement win the material. In this example, we present a survey question. When the student submits their response, they can immediately compare their response with all previous respondents 40. Using the Compare button 41 the student can select specific demographics and observe how particular subgroups responded to the question. All student input is stored in a database and this input may cause the entire presentation to branch and provide lessons, images and activities that are customized to the established student inclinations and needs.

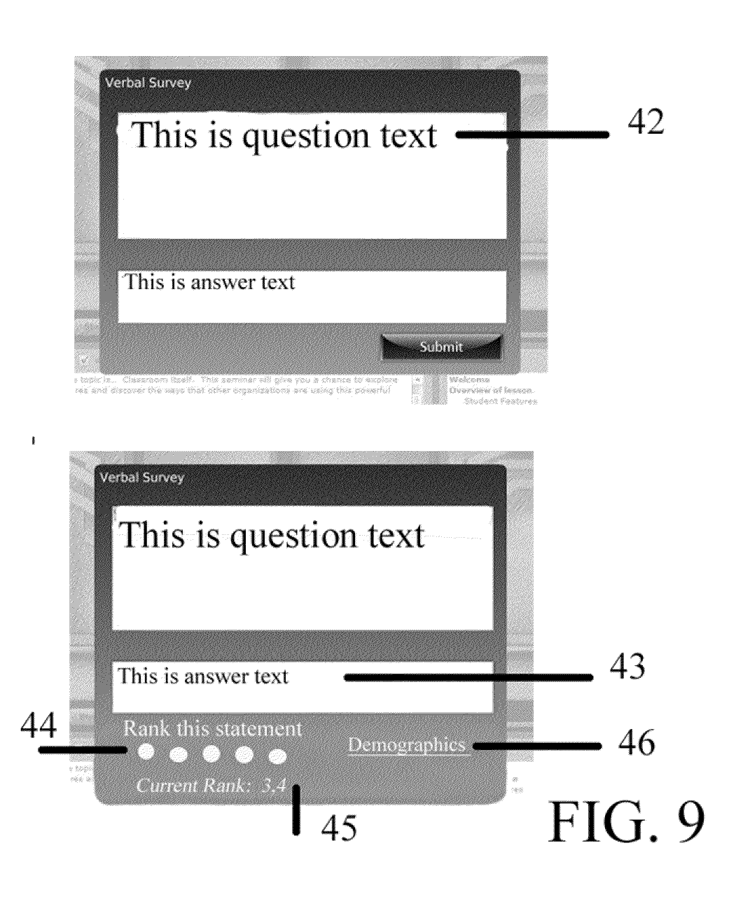

FIG. 9 shows another example of a learning link activity. When the student submits their answer 44, they can immediately review answers provided by other students 43. The student can rate responses by other students 44 and can view the current average ranking of the response 45. Finally, the student can use the Compare button 46 to select specific demographics and observe how particular subgroups responded to the question. All student input is stored in a database and this input can be used to establish a catalog of best practices.

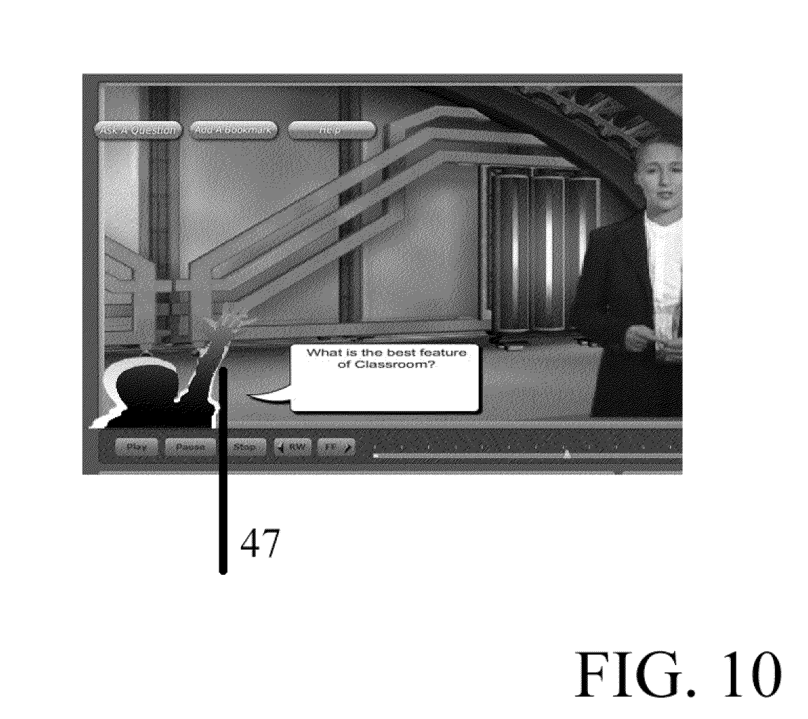

FIG. 10 shows a moment in the lecture hall where a virtual student 47 asks a question. If the student clicks on the image, the lesson stops and the teacher provides a prerecorded video-based answer to the question.

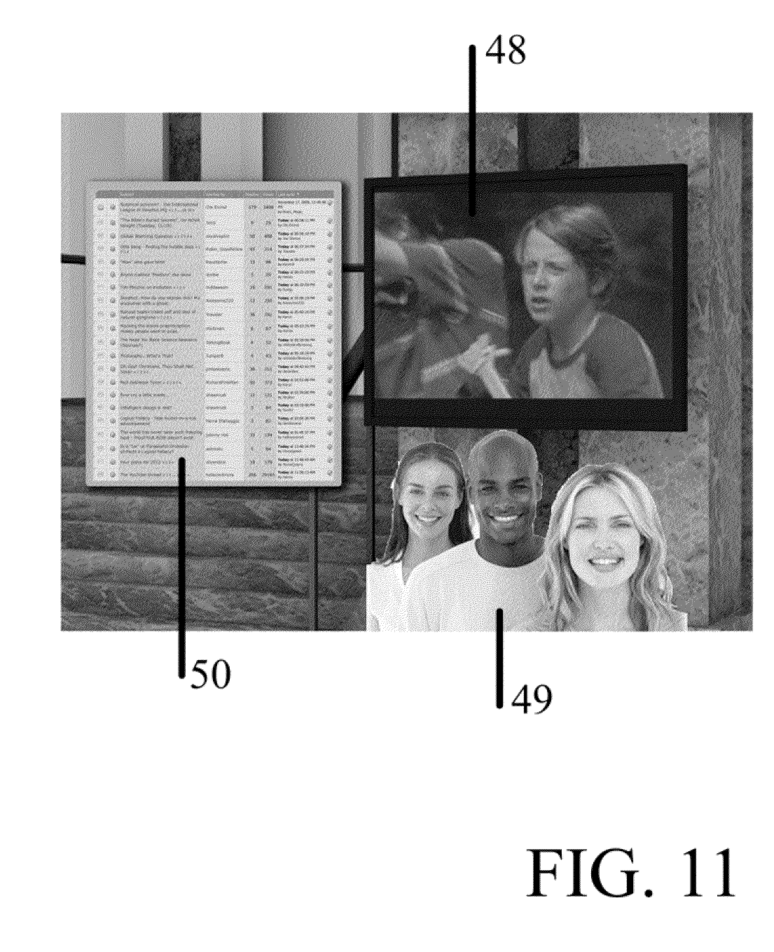

FIG. 11 shows the recitation forum room. Within this room, students can observe provoker videos 48 that are designed to inspire meaningful conversation. They can also rollover the images of people 49. Doing so causes these images to change to videos and expresses a particular point of view. Additionally, the student can participate in threaded discussion forums 50.

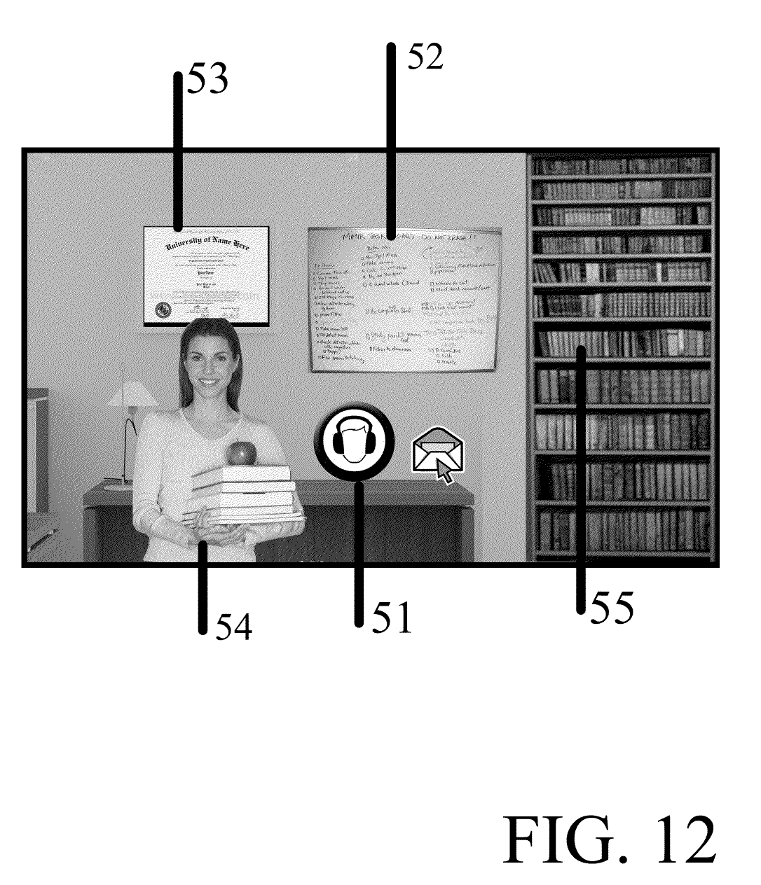

FIG. 12 shows the Tutor's Office. The Tutor's office provides a number of tools that promote student-teacher communication including Voice-over-IP 51, white board conversations 52, and an option to submit an asynchronous email question 53. Clicking on the “Diploma” 54 opens a window displaying the teacher's resume. The tutor character will be rendered as an animated character who will talk to students using text to voice technology 55. The bookshelf will provide book-shaped buttons that provide access to course recourses such as additional readings, web links, and a catalog of highly rated response to the verbal surveys described above (FIG. 9).

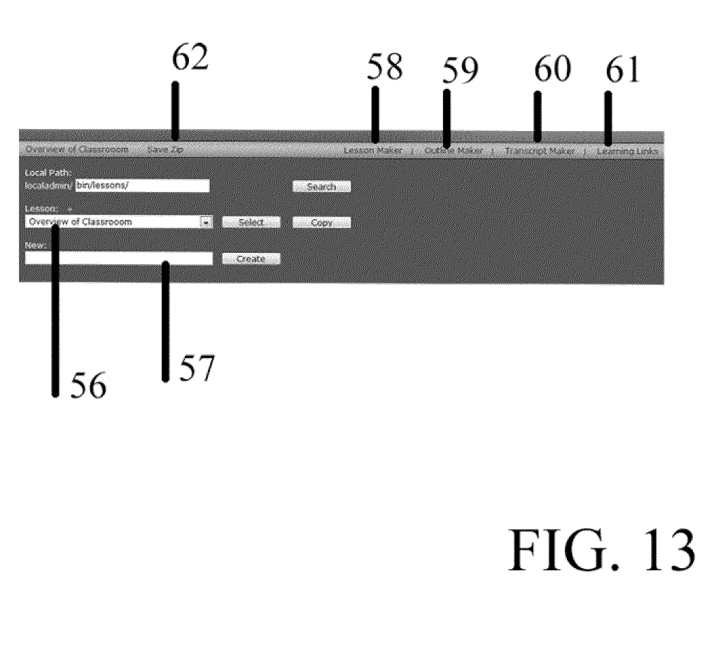

FIG. 13 shows the course selection page which is used by content authors. An author uses this page to select which course 56 they will author or whether to create an entirely new course 57. Once a course is selected, the author may proceed to any of four authoring tools. The LessonMaker tool 58 is where they author multimedia lessons. OutlineMaker 59 is where they build navigable outlines. TranscriptMaker 60 is where they add hypertext to transcripts that are used within the product. LearningLinks 61 is where the authors create any of the various types of Learning Links.

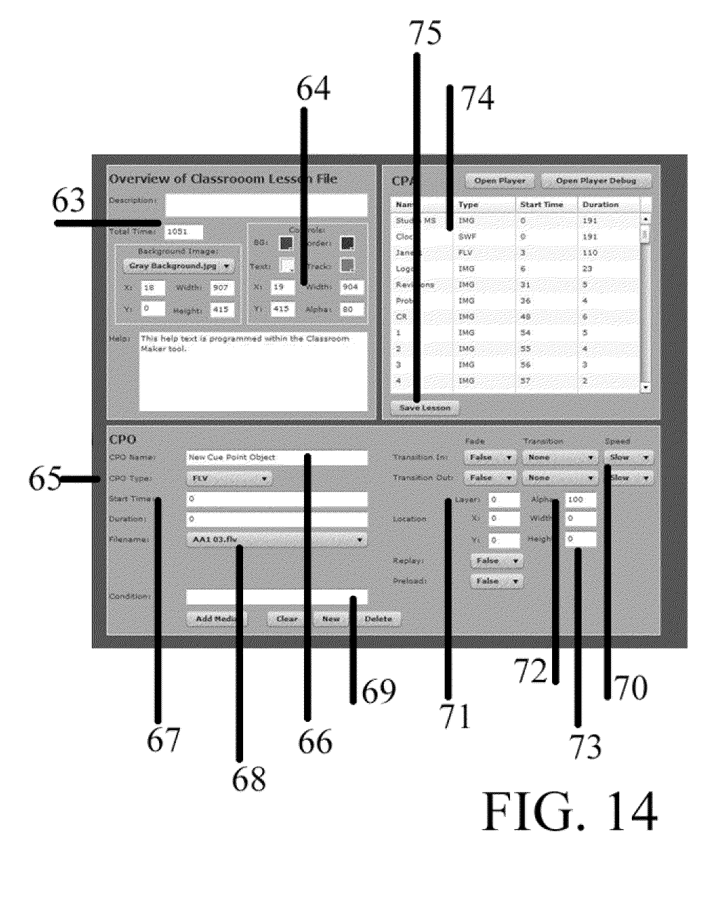

FIG. 14 shows the environment where authors specify the media and properties of the media that constitute a single dynamic lecture presentation. The author begins be defining the total duration of the lesson 63. They then define characteristics of the student control bar (See FIGS. 3, 4) including its position and colors 64. The author can then add a new object to the lesson be defining its properties in the Cue Point Object menu. They begin by giving the object a name 65 and then specify the type 66 of object that is being added. The media types can include, but are not limited to, images, videos, learning links, audio, executables, HTML, interactive mouse-over effects, and scrollers. Next, the author specifies the start time 67 and duration of each object and the corresponding media files 68 that are required for the object. The author can also specify a condition 69 that must be met for this object to be presented. For example, the condition might “If VariableA==3.” This capacity to specific conditionals enables the author to create alternative versions of the presentation that are customized to the student needs and interests. It also enables the embodiment to pace the presentation to the student's ability to comprehend and learn. The author can then specify 70 how the object will transition on and off screen. Finally, the author specifies where the object will appear on screen. These properties include the layer 71 on which the object will appear, its transparence 72, and the X/Y coordinates 73 as well as the width and height of the object. The collection of objects in the lesson are represented in the Cue Point Array 74 which provides an overview of the entire lesson. On completion, the author hits the “Save Lesson” button 75 to save a copy of the lesson.

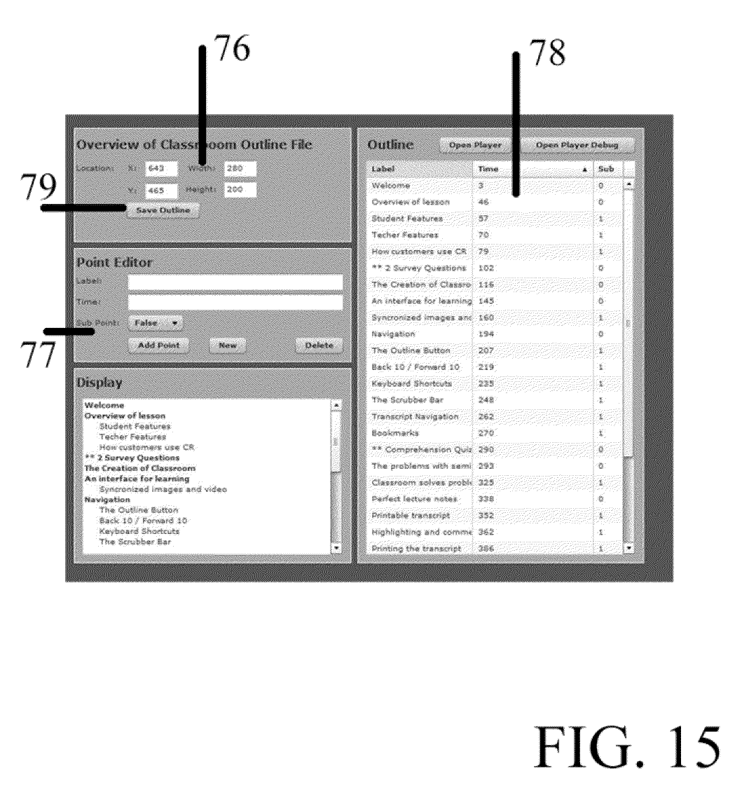

FIG. 15 shows the OutlineMaker tool. The author begins by defining where the outline will appear on the student screen 76. Next, they add an outline item 77 by giving it a label, defining its corresponding time in the lesson, and whether it is a sub-point. The collection of all of the outline items is displayed 78 for review, and the author saves the lesson by hitting the Save Outline button 79.

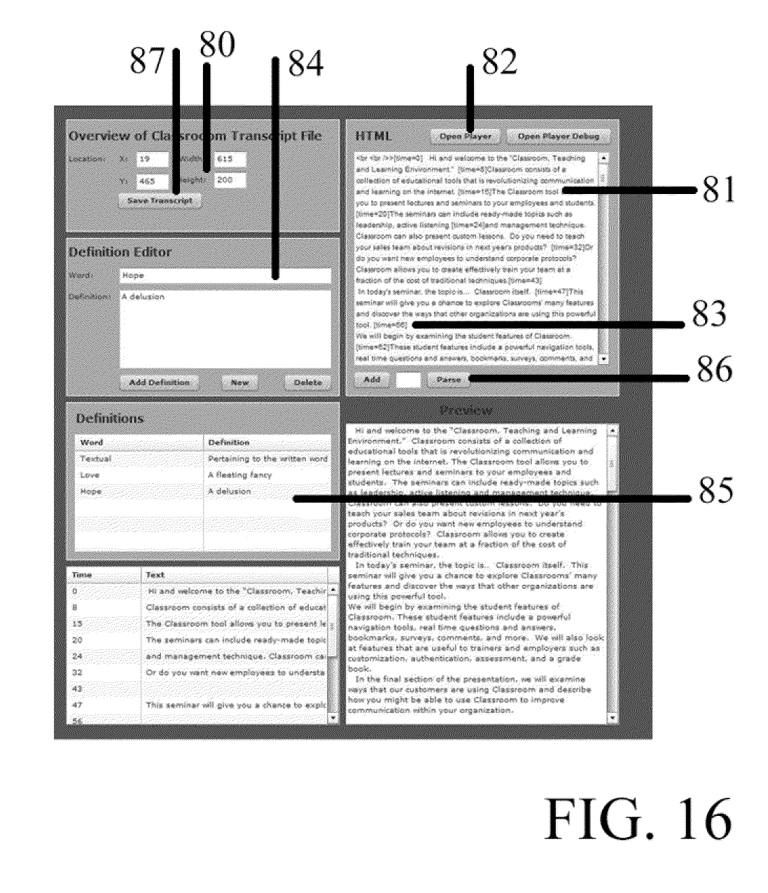

FIG. 16 shows the TranscriptMaker Tool and the Definition tool. The author begins by defining the location and size of the transcript 80 as it will appear on the student screen. They then type or paste the transcript into the transcript box 81. They then click the “Open Player” button 82 to open an instance of the student lesson in a player. As the lesson is playing, the author may control-click anywhere in the transcript to add the lesson timer value into the transcript 83. The author can then add words and corresponding definitions using the Definition Editor 84. These words are added to the definition list 85. Finally, when the author clicks the Parse button 86 the program embeds time codes and hypertext into the transcript. Hitting the Save Transcript button 87 saves the Transcript file.

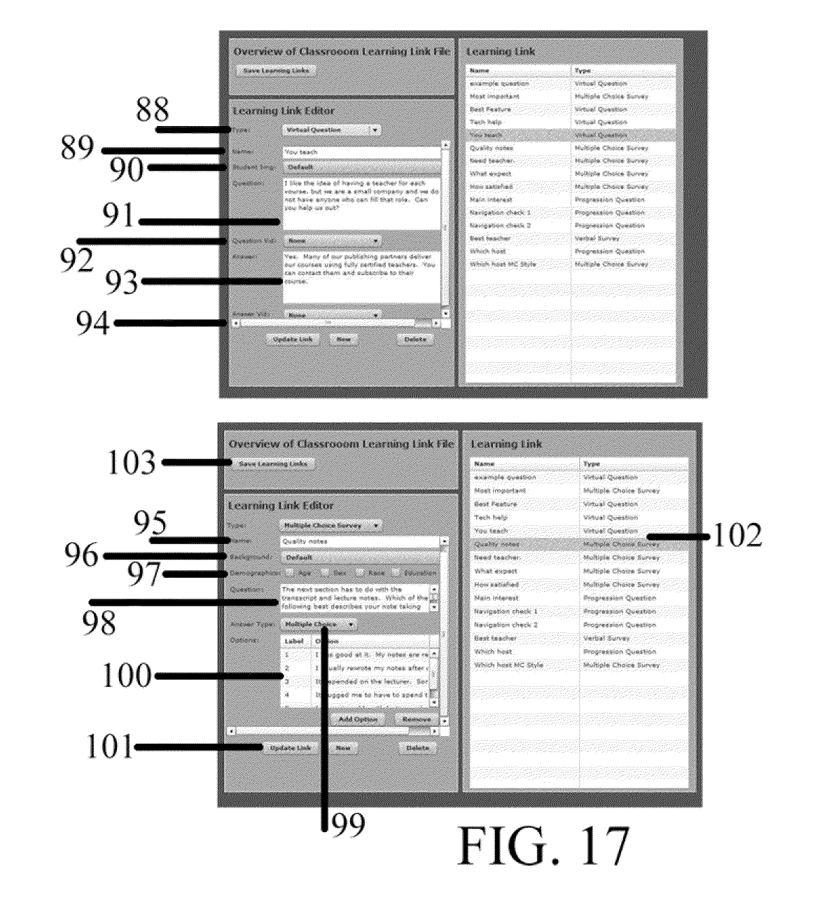

FIG. 17 shows the LearningLinkMaker tool. The author begins by identifying the type of LearningLink they want to create. If they choose a create-a question 88 that will be asked by a virtual student then they are prompted to provide associated properties including Name 89, Media file for the student image 90, the question being asked 91, the video file associated with the question 92, the text of the answer 93, and the media file or video associated with the answer 94.

If the author chooses to create a multiple choice survey or a verbal survey, then they are prompted to provide associated properties including Name 95, Media file for the background image 96, the demographics that will be used for sorting the answers 97, the text of the question being asked 98, the answer type 99, and the options for the answers 100. The author can save/update a LearningLink by clicking the Update button 101. Doing so adds it to the display of all LearningLinks 102. Clicking “Save Learning Links” 103 saves the list of links.

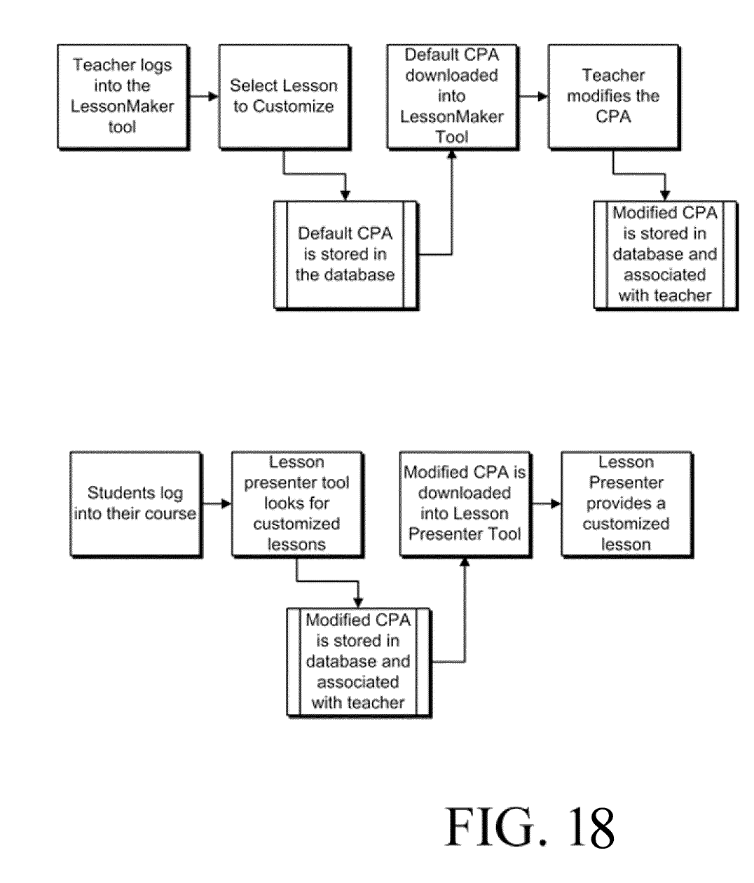

FIG. 18 shows the Teacher Interface. The teacher modifies the default version of the CPA and saves it into a different area of the database. In turn, students receive can receive a lesson that was modified by their teacher. The teacher logs into the LessonMaker tool 103 and selects a lesson to modify 104. The default vision of the CPA 107 downloads from the database 105 and the teacher modifies it 106. The teacher can then save the modified version to the database 108 where is it stored with a link to his or her name. In turn, when students log into the course 109, the LessonPresenter tool looks for customized lessons in the database 113. If it exists, it is downloaded into the LessonPresenter tool 111 and delivered to the students 113.

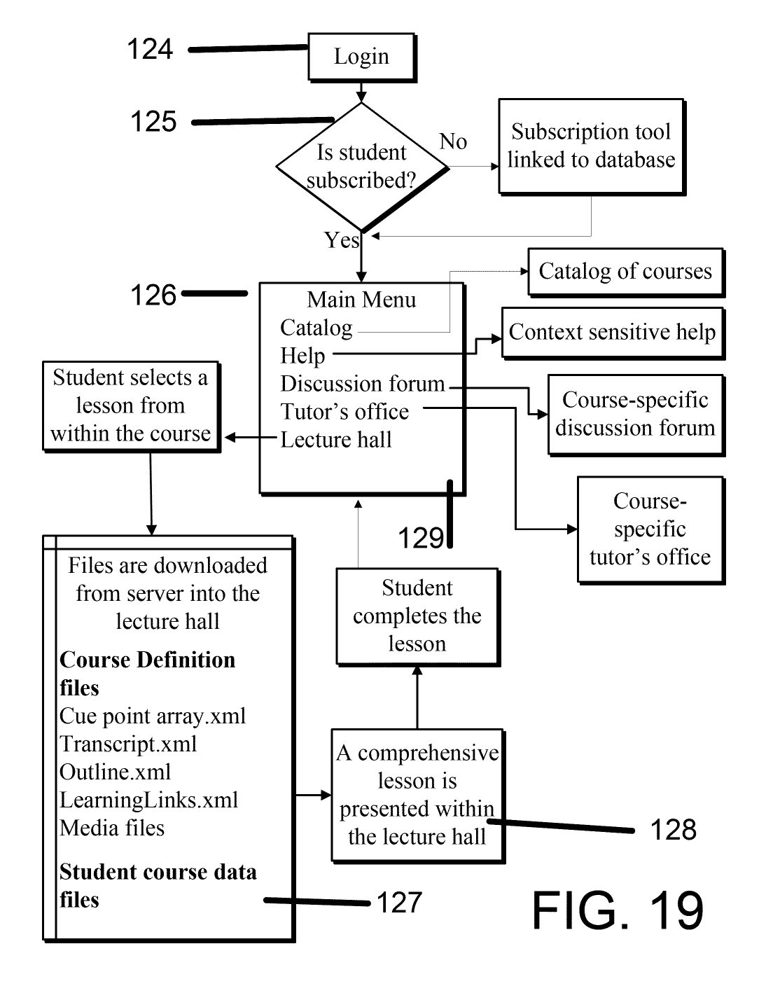

FIG. 19 shows an aspect of a preferred embodiment's standard operational flow. As the user proceeds through the program, information from the user's device is sent over the Internet to the server for processing and storage in the database. The information sent is either entered by the user or automatically generated by the system to aid in tracking the user's activity and position in the program. The first information the user enters is their login information 124. When the server-side processing verifies that the user's username and password match a valid user, that information is passed back to the user's device and the user is moved to the home page 126 of the program (see also FIG. 2). If the user is not authenticated, they are asked to login again. A successful login connects the user to the program and their personalized information stored in the database. This includes information for all courses in which they are enrolled.

Still referring to FIG. 19 and also to FIG. 2, after logging in, the user has the option of choosing which course they want to sign in to 2. Selecting a course references that course record in the database, and all of that course's lessons are recalled to populate the syllabus 3. The program also references the student's prior record of activity within this lesson, and uses this information to populate the “Status” component of the syllabus 127. The status will be listed as either “Not Begun,” “In process,” or “Completed.” The system is able to return the user's status because the user's history within the program is tracked. Each activity in the program has a unique identifier. When a user selects a page, the system sends that unique identifier over the Internet to be stored in the database on the server.

After the student chooses a lesson, the embodiment downloads all of the course definition files and the related student data. The lesson is then presented in the lecture hall 129 (see FIGS. 3 and 7a). The student has the option to review the catalog of courses and context sensitive help. They can also go to the course-specific discussion forum or to the course-specific tutor's office (see FIG. 12). When the student clicks on one of the Lessons within the syllabus 3, they then launch that lesson within the Lecture Hall 128. The student also has the option to launch the forum 6 or the Tutor's Office 7 that are associated with this particular course. Finally, the student can view context sensitive help 5 and to view the catalog 4 where they can enroll in additional courses 129.

When a student launches a lesson within the lecture hall, the program accesses the database for that lesson and loads the media folder as well as the four XML files that were created by the author. The media folder contains all of the media elements (images, videos, etc), that were called for when the author created the lesson (FIG. 14). These media elements are loaded into the program 127.

These first of the XML files is, for example, called Lesson.xml. The Lesson.xml file contains the Cue Point Array which was created within the LessonMaker tool (FIG. 14). The cue point array defines each of the cue point objects that will be presented during the lesson. As illustrated in FIG. 14, the CPA contains a description of each object, its time of its onset, its duration, its transition on and off the screen, its position on screen, and whether or not its appearance is conditional on the state of some variables. In turn, this technology can be used to present lessons that are customized on-the-fly to individuals who provide certain collections of inputs (FIG. 22).

The second XML file that is loaded is, for example, called Outline.xml. This file was created by OutlineMaker (FIG. 15) and it consists of a parsed list of Outline Statements and each statement's corresponding time of occurrence within the presentation. After loading the file, the program embeds the “time of occurrence” as hypertext information within the presented outline.

The third XML file that is loaded is, for example, called Transcript.xml. This file was created by TranscriptMaker (FIG. 16) and it consists of a parsed list of Transcript text and each sentence's corresponding time of occurrence within the presentation. After loading the file, the program embeds the “time of occurrence” as hypertext information within the presented transcript.

The Fourth XML file that is loaded is, for example, called LearningLink.xml. This file was created by LearningLinkMaker (FIG. 17). It consists of a parsed list of each of the LearningLinks from the lesson. The parsed list includes the following information about each learning link: its type, name, question, answer, and associated media files. After loading, the program makes this information and properties available to the learning link player.

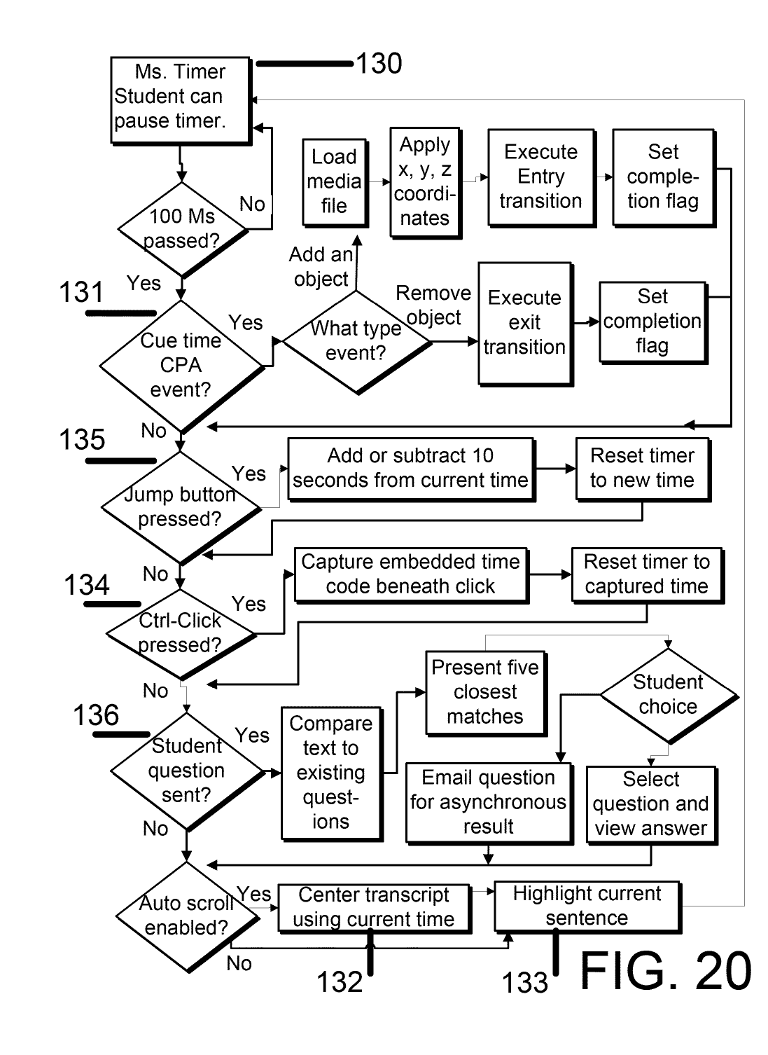

FIG. 20 illustrates how a time-based polling system enables another aspect of an embodiment to provide a variety of functionality. The millisecond clock monitors defines the progress of the lesson timeline. Student can pause and restart this timer 130. The embodiment continually polls for events that occur within in the Cue Point Array and executes them at the appropriate times 131. The embodiment also monitors for navigational inputs 135, 136, student questions 137 to ensure the transcript movement is synchronized with the speaker. Finally, it highlights the sentence currently being spoken 133.

During the presentation of a lesson, a timer keeps millisecond accurate track of the master time of the presentation 130. When the user hits pause (or launches a learning link activity), the master timer is paused. On “Play,” the master timer resumes. While the lesson is playing, the master timer continually polls the cue point array. In turn, the program causes each, of the cue point objects to enter the screen at specified time, at the specified location and layer, and using the specified transition 131, 15 (FIG. 2), 19 (FIG. 2). The master timer also directs objects to exit the screen at the specified time and using the specified transition. This technology enables the program to intermediately change all of the media elements providing the impression that the image is being viewed from another angle. These changes enhance the sense of immersion.

The cue point array can include executable files which can perform a very variety of functions. As an example, these executables could provide a virtual on-screen clock 19 (FIG. 3), a ticker tape presenter 37 (FIG. 7B), an interactive experiment, or an enriched simulation. These executables can be placed anywhere on the screen and called on and off screen at any time by setting parameters within the CPA. The content required for these executable files, such as the text played within the scroller, can be input as part of a CPO 65 (FIG. 14), and it is stored within the XML of the Lesson.xml document.

While the lesson is playing, the master timer also monitors the position of the transcript in the transcript viewer area 13 (FIG. 3). The program compares the Master Timer value and locates the transcript text that corresponds to this time. In turn, it causes this corresponding time to remain centered within the transcript window 132 (FIG. 20). If the auto scroll box 24 (FIG. 4) is unselected, the centering technology is disabled. The program also determines which block of text within the transcript has associated timecode that matches the current master time. In turn, it adds temporary HTML highlights to this block of text to make it easier for the user to identify it 133.

When the student control-clicks on the transcript 134, 24 (FIG. 4), the program determines the position of the click and reads the underlying hypertext that indicates that associated time code. In turn, the Master Timer is reset to this time. In turn, the program resets the appropriate activities of the Cue Point Objects to correspond to the new Master Timer. When the student clicks on a line within the outline 12 (FIG. 3), and 29 (FIG. 6), the program determines the position of the click and reads the underlying hypertext that indicates its associated time code. In turn, the Master Timer is reset to this time. In turn, the program resets the appropriate activities of the Cue Point Objects to correspond to the new Master Timer.

When the student clicks the jump backward or jump forward button 135, 14 (FIG. 3), the program adds or subtracts 10 seconds from the Master Timer. In turn, the program resets the appropriate activities of the Cue Point Objects to correspond to the new Master Timer.

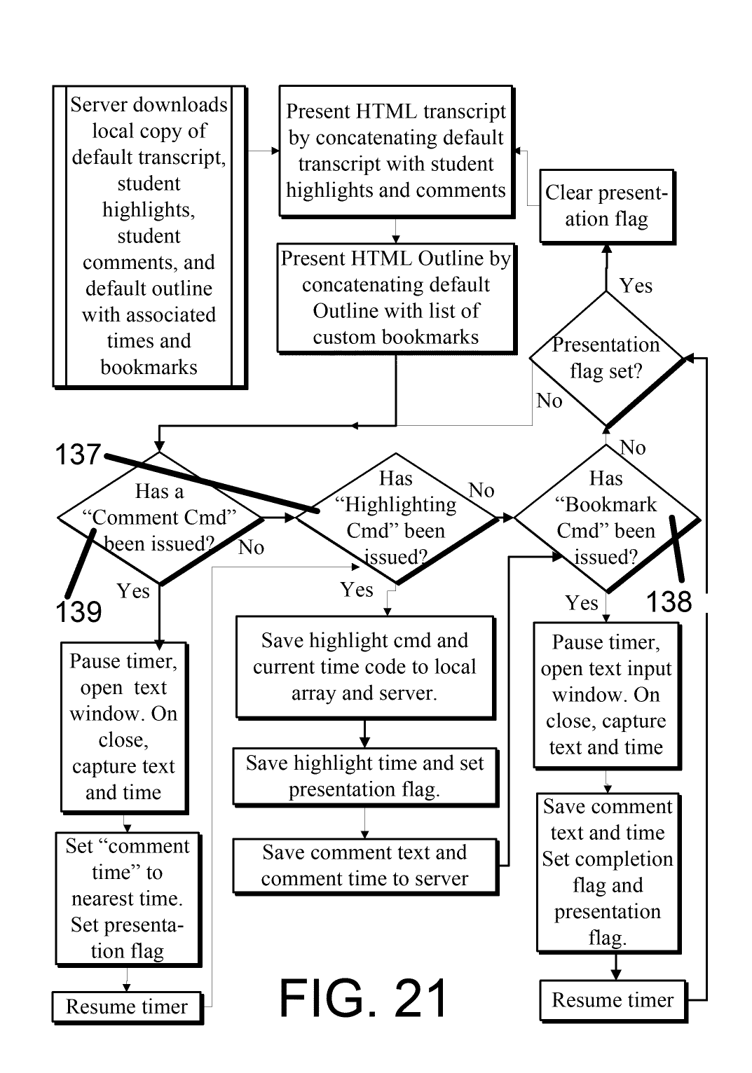

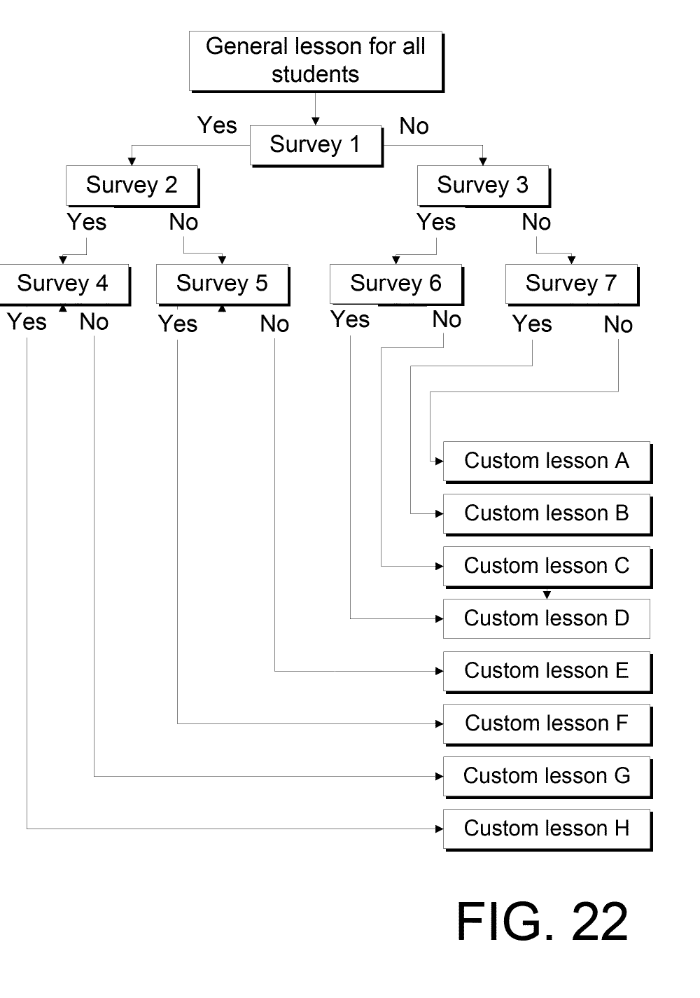

Still referring to FIG. 20 and also to FIG. 21, when the student clicks on the transcript, the program determines both the button-down and button up position of the cursor 137, 22 (FIG. 4). In turn, it detects the body text beneath the clicks and adds HTML to this text which causes it to appear highlighted. When the student clicks on the “Ask a question” button 136, 16 (FIG. 3) the master timer is paused and the program opens a text-input box 31 (FIG. 7A) where the student can type in their question. When the student hits the submit button, the words contained within of the question are parsed and we compare these words to the words within previously asked questions which are stored in the database. In turn, we present students with the list of the five questions that most closely match the question asked 32 (FIG. 7A).

If the student clicks on one of the five provided questions, we then present them with the answer that is associated with that question within the database. If the student clicks on the “Rephrase the Question” option 33 (FIG. 7A), the program deletes the five provided options and returns to the text input box 31 (FIG. 7A). If the student clicks “Submit Question to Teacher,” 34 (FIG. 7A) the question is forwarded to the teacher using standard communication techniques such as email. If the student clicks “Cancel” 35 (FIG. 7A), the program deletes the five provided options and the program returns to the lesson which resumes.

If the student clicks on the “Add a bookmark” button 138, 17 (FIG. 3), the master timer is paused and we open a textbox where they can enter the text of their bookmark. When this is saved, the program combines the new bookmark text, along with the current master time, and adds this information to the local array that presents the on-screen Outline. It also saves this data to the student's database for this lesson such that the saved bookmark will be present the next time the student returns to this lesson.

If the student clicks on the “Add a comment” button 139, 26 (FIG. 4), the master timer is paused and we open a dialogue box which prompts the student to indicate which aspects they want to print where they can enter the text of their comment. When this is saved, the program notes the current master time and determines the position within the transcript that most closely corresponds to this time. In turn, the program adds this text into the local array that contains the hypertext transcript. It also saves this data to the student's database for this lesson such that the modified transcript will be present the next time the student returns to this lesson 30 (FIG. 6).

If the student clicks on the “Print Transcript” button 26 (FIG. 4), the master timer is paused and we open a dialogue box (FIG. 5) where they can indicate which aspects of they wish to print. All of the printable components, including the transcript, student highlights, student comments, synchronized imagers, navigable outline, and data from learning links, is stored within a database. Once the student identifies which items they want to print, the program parses all of these components based on the time of their occurrence. In turn, these are organized into a single document which is placed into a browser window. The student can print this window using the browser's Print command.

FIG. 22 illustrates how a series of survey questions and student input can enable the embodiment to create on-the-fly customized lessons.

When the program presents a LearningLink, the program calls a routine that presents the question onto the screen (FIGS. 8 and 9). The student response is stored in the database along with peer rankings and other information that identifies the student and their demographics. Later this information is retrieved for presenting graphs showing group data.

Users access the enhanced education program using this system and method through an Internet-connected device, such as a Web browser or a standalone application on a desktop computer, laptop computer or other portable Internet-connected devices with sufficient capabilities. The instructional notes, tasks, goals and learning reflections can also be accessed through handheld devices, PDAs, Web-enabled cell phones and other portable Internet-connected devices that may be developed.

FIG. 21 illustrates how the embodiment continually polls and enables highlighting, comments, and bookmarks.

The above described embodiments should not be construed as limiting the scope of the present immersive interactive environment for asynchronous learning and entertainment but as merely providing illustrations thereof. It will be apparent to one of ordinary skill in the art that various changes and modifications can be made to the claimed invention without departing from the spirit and scope thereof. Many variations and applications are possible, as shown by the following non-exclusive examples.

Embodiments of the present immersive interactive environment can be used as a substitute for printed textbooks wherein the lecturer, accompanied by activities and pedagogical tools, “performs” the student's textbook. Immersive lessons training lessons can be programmed to work within any online curriculum and education system based on the general programming knowledge of one of ordinary skill in the art, such as linking an embodiment into APIs within learning management systems and thereby enable these tools to provide more enriched within these K-12, higher education and corporate systems. Immersive lessons can be used to deliver distance education courses in K-12, college, or continuing education environments thus enabling the delivery discrete courses or comprehensive curriculums and providing lectures, textbook performances, and tutorial sessions. Immersive lessons can be used as a tool for both political and advertising communications. The interactive tools can solicit information from the viewer and in turn, presenters can provide a message that is customized to the viewer's interests.

Embodiments of the present immersive interactive environment can be used to enhance corporate training. For example, the lessons could provide information about products, In turn, built-in assessment tools allow us to provide certificates of completion to individuals and certificates of compliance to employers. Immersive lessons can be used to provide custom continuing professional education in areas such as law, medicine, and psychology. The embodiments capacity for incorporating compelling activities simulations allows extensive ability to provide complex simulations. Immersive lessons can be used by publishers to new distribution channels for their traditional text-based books. Immersive lessons provide a rich collection of additional capabilities that will provide an increase in value over traditional print media.

Embodiments of the present immersive interactive environment can be used to provide mini lessons that are distributed either on local medium or over a network. These mini lessons might include a great-lecture series, how-to presentations, editorial presentations, or profiles of famous books. These lessons could be for-sale or supported by advertising revenue. Immersive lessons can improve the self-help experience in areas such as health, diet, fitness, mental health, smoking, job search, screen writing, and car repair. Immersive lessons, along with the ability to personalize the lessons will allow the customer to specifically address the viewer's needs. Furthermore, companies will be able to collect massive amount of information about viewers which will enable them to efficiently target future marketing Immersive lessons will allow companies to provide more effective technical manuals and guides. Companies that sell products with accompanying manuals want their customers to learn about the product and solving problems with the product. Frequently, those manuals cover aspects of the product that the user may not be interested in or find relevant to them. By providing immersive lessons, customers will be able to provide more effective training and the company benefits by reducing their support costs because the customer is essentially supporting themselves.

Embodiments of the present immersive interactive environment can be substitute for employee manuals and human resource guides. Employee manuals and human resource guides can be considered instructional materials for a company's employees. It is important that each employee learn rules of conduct, guidelines, and all other information that a company deems is important. By immersive lessons, employers can insure better communication and employees can create their own library of information that is most relevant to their own situation.

Embodiments of the present immersive interactive environment can be a more effective means to conduct focus groups polling. Users listen to immersive presentations work through materials and are encouraged to note the items or information that is most interesting to them. Our system makes this easy and customers gain access to unique, detailed profile of users and deeper insights into their preferences.

For example, computer based technology enables multiple, physically distinct computers that are in communication with one another to function equivalently to a single computing device from the perspective of a user. Two non-limiting examples of such technology and applications are distributed computing projects and web-based software applications.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I claim:

1. A method of enabling customization of a lesson embodied in at least one lesson data file residing on a computing device, said method comprising:
a) providing a lesson data file editing program embodied in at least one sequence of computer executable instructions to an instructor by allowing said instructor to execute said editing program via a computing device, said editing program enabling said instructor to customize a lesson data file; and
b) providing at least one general lesson data file to said instructor by allowing said instructor to access said general lesson data file via said computing device, thereby enabling said instructor to customize said at least one general lesson data file via said editing program to create a customized lesson, said customized lesson being embodied in at least one customized lesson data file residing on said computing device, said at least one customized lesson data file including data corresponding to at least one selected lesson content segment; and
c) wherein a student is capable of accessing said at least one customized lesson data file via a lesson presentation program embodied in at least one sequence of computer executable instructions enabling said student to perceive said customized lesson.

2. The method of claim 1, wherein said at least one general lesson data file includes a plurality of general content segments and said editing program enables said instructor to selectively remove general content segments from said plurality of general content segments, selectively modify general content segments of said plurality of general content segments, selectively add new content segments to said plurality of general content segments, and select a chronological order of presentation of said at least one selected content segment.

3. The method of claim 1, wherein said lesson presentation program includes a plurality of components corresponding to groups of computer executable instructions operable to control the manner in which said at least one student perceives said customized lesson and said editing program enables said instructor to predetermine how said plurality of components will operate.

4. The method of claim 3, wherein said customized lesson is to be perceived by said student at least in part via graphical representations on an electronic display and the method further comprises enabling said instructor to use said editing program to modify said at least one customized lesson data file to select how said graphical representations are to be arranged on said display.

5. The method of claim 4, wherein said plurality of components includes a classroom component, said classroom component being operable to cause said student to perceive said customized lesson being delivered in a graphical representation of a classroom and said editing program enables said instructor to modify said at least one customized lesson data file in a manner that controls characteristics of said classroom component.

6. The method of claim 5, wherein at least one of said controllable characteristics is an observer viewpoint of said graphical representation of said classroom.

7. The method of claim 4, wherein said plurality of components includes a teacher component, said teacher component being operable to cause said student to perceive said customized lesson as being audibly delivered by a graphical representation of a teacher and said editing program enables said instructor to modify said at least one customized lesson data file in a manner that controls characteristics of said graphical representation of said teacher and characteristics of said audible delivery.

8. The method of claim 7, wherein said controllable characteristics of said graphical representation of said teacher includes perceivable physical characteristics of said teacher.

9. The method of claim 4, wherein said customized lesson includes a plurality of content segments, said plurality of components includes a transcript component, said transcript component being operable to cause said student to receive an annotatable transcript of said customized lesson embodied in at least one transcript data file, said annotatable transcript being linked to corresponding segments of said at least one customized lesson data file.

10. The method of claim 4, wherein said customized lesson relates to a topic, said plurality of components includes a question component, said question component being operable to cause said student to perceive said customized lesson to be interrupted by a representation of a student asking said at least one preexisting question pertaining to said topic and to perceive a representation of a teacher answering said question.

11. A method of providing a customized lesson to a student, said customized lesson embodied in at least one lesson data file residing on a computing device, said method comprising:
a) accessing at least one general lesson data file residing in an electronically accessible storage medium via a computing device, said at least one general lesson data file corresponding to a general lesson;
b) modifying said at least one general lesson data file via said computing device thereby creating at least one customized lesson data file residing in an electronically accessible storage medium and corresponding to a customized lesson and including at least one selected content segment;
c) communicating said at least one customized lesson data file to a student via an electronic communication medium; and
d) enabling said student to access said at least one customized lesson data file via a computing device in order to perceive said customized lesson.

12. The method of claim 11, wherein said at least one general lesson data file includes a plurality of general content segments, said general lesson corresponds to a primary topic and said general content segments correspond to sub-topics related to said primary topic, and the step of modifying said at least one general lesson data file comprises selecting at least one of said plurality of general content segments for inclusion in said at least one customized lesson data file.

13. The method of claim 12, wherein the step of modifying said general lesson data file further comprises selectively modifying at least one of said selected content segments.

14. The method of claim 12, wherein the step of modifying said at least one general lesson data file further comprises selectively creating at least one new content segment and including said at least one new content segment in said at least one customized lesson data file.

15. The method of claim 12, wherein the step of modifying said at least one general lesson data file comprises selecting a chronological order of presentation of said selected content segments.

16. The method of claim 11, wherein the step of enabling said student to access said at least one customized lesson data file comprises providing said student with a lesson presentation program embodied in at least one sequence of computer executable instructions, said presentation program including a plurality of components, said plurality of components being operable to control the manner in which said customized lesson is presented to said student the step of modifying said at least one general lesson data file comprises preselecting how said plurality of components will operate as said lesson is presented to said student.

17. The method of claim 16, wherein said student will perceive said customized lesson at least in part via graphical representations on an electronic display and the step of modifying said at least one general lesson data file includes preselecting characteristics of said graphical representations.

18. The method of claim 16, wherein said plurality of components includes a classroom component, said classroom component being operable to cause said lesson presentation program to present said customized lesson as being delivered in a graphical representation of a classroom and the step of modifying said at least one general lesson data file comprises preselecting characteristics of said graphical representation of said classroom.

19. The method of claim 16, wherein said plurality of components includes a teacher component, said teacher component being operable to cause lesson presentation program to present said customized lesson as being audibly delivered by a graphical representation of a teacher.

20. The method of claim 16, wherein said plurality of components includes a transcript component, said transcript component being operable to cause said student to receive an annotatable transcript of said customized lesson embodied in a transcript data file, said annotatable transcript being linked to temporally corresponding portions of said at least one customized lesson data file.

21. The method of claim 16, wherein said plurality of components includes a question component, said question component being operable to cause said lesson presentation program to interrupted presentation of said customized lesson by a representation of a student asking a question pertaining to said topic and a representation of a teacher answering said question, and the step of modifying said at least one general lesson data file comprises preselecting said question and preselecting a temporal position in said customized lesson for operation of said question component.

22. The method of claim 16, wherein said plurality of components includes a survey component, said survey component being operable to cause said lesson presentation program to present said student with at least one survey question prior to being presented with said customized lesson and the step of modifying said general lesson comprises selecting a plurality of alternate selected content segments and determining which of said alternate selected content segments will be presented to said student as a function of a response of said student to said at least one survey question.

23. A method of customizing a lesson to be perceived by a student, said lesson being embodied in at least one lesson data file residing in a first section of electronic storage and including a plurality of variable content segments, the variation of which is controllable by a computing device having access to said first section of electronic storage, the method comprising:
a) causing said computing device to present said student with at least one survey including at least one question via a survey program embodied in a first sequence of computer executable instructions accessible by said computing device, said survey being embodied in at least one survey data segment residing in a second section of electronic storage accessible by said computing device;
b) causing said computing device to receive a response to said at least one survey from said student, said response being embodied in a response data segment received by said computing device;
c) causing said computing device to create a customized lesson by making variations to said at least one lesson data file via a lesson modification program embodied in a second sequence of computer executable instructions accessible by said computing device, said variations based at least in part on comparing said response to a preexisting set of possible responses, said preexisting set of possible responses being embodied in a survey response data segment residing in a third section of electronic storage accessible by said computing device; and
d) causing said computing device to present said student with said customized lesson via a lesson presentation program embodied in a third sequence of computer executable instructions.

24. A method of enabling a student perceiving a preexisting lesson via an electronic medium to receive an answer to a question, said preexisting lesson being embodied in at least one lesson data file residing in a first section of electronic storage accessible by a computing device, the method comprising:
a) detecting the initiation of a question operation by said student during a presentation of said preexisting lesson;
b) causing the presentation of said preexisting lesson to be paused;
c) receiving a first question from said student;
d) comparing said first question to be compared to a list of preexisting questions having corresponding answers,
e) selecting at least one of said preexisting questions as a potential match to said first question;
f) presenting said at least one selected pre-existing question to said student;
g) prompting said student to select which if any of said at least one selected pre-existing question as a match to said first question; and
i) receiving input from said student;
j) wherein if said input received from said student identifies a second question from said at least one selected preexisting questions as a match to said first question:
(j-1) presenting said student with a corresponding preexisting answer to said second question;
(j-2) prompting said student to indicate if said pre-existing answer is satisfactory to said student; and
(j-3) if said student indicates said pre-existing answer is satisfactory, resuming presentation of said lesson, otherwise returning to step (d); and
k) wherein if said input received from said student does not identify a second question from said at least one selected preexisting questions as a match to said first question:
(k-1) submitting said first question to an instructor; and
(k-2) resuming presentation of said lesson; and
l) wherein the method is embodied in at least one sequence of instructions performable by said computing device.

25. The method of claim 24, wherein step (c) comprises receiving said first question as a first data element corresponding to human readable text, said list of preexisting questions is in the form of an array of second data elements corresponding to human readable text and step (d) comprises performing a text matching operation comparing said first data element to said array of second data elements.

26. The method of claim 24 wherein step (c) comprises receiving said first question as a first data element corresponding to human speech, said list of preexisting questions is in the form of an array of second data elements corresponding to human speech and step (d) comprises performing a speech recognition operation comparing said first data element to said array of second data elements.

27. The computer readable medium of claim 24, said list of pre existing questions including at least one question submitted to said instructor during a previous operation of the method in accordance with step (k-1).

28. The method of claim 24, wherein step (d) comprises searching said list of preexisting questions for questions selected by other students at a similar temporal point in the lesson

29. The method of claim 24, further comprising, subsequent to step (k-2), the steps of:
(k-3) receiving a corresponding answer to said first question from said instructor; and
(k-4) adding said first question and said corresponding answer to said list of preexisting questions.

30. A computer readable medium storing instructions and data for causing a computing device to enable customization of a lesson to be communicated to a student, said computer readable medium comprising:
a) a first data section, said first data section corresponding to a general lesson having a plurality of general content segments;
b) a first group of instructions, said first group of instructions corresponding to a lesson editing tool, said editing tool enabling an instructor to modify said first data section, thereby creating second data section corresponding to a customized lesson, said customized lesson including at least one selected content segment;
c) a second group of instructions, said second group of instructions corresponding to a lesson publishing tool, said lesson publishing tool enabling said instructor to distribute said customized lesson to at least one student.

31. A computer readable medium storing instructions and data for causing a computing device to deliver a customized lesson to a student, said customized lesson being based on a first data section corresponding to a preexisting general lesson having a plurality of variable content segments, the variation of which is controllable by said computing device, said computer readable medium comprising:
a) a first group of instructions, said first group of instructions causing said student to be presented with at least one survey made up of at least one question and further causing said computing device to receive a response to said at least one survey from said student;
b) a second group of instructions, said second group of instructions including instructions for causing said computing device to create said customized lesson by making variations to said general lesson, said variations based at least in part on said response to said at least one survey from said student; and
c) a third group of instructions, said-third group of instructions causing said student to be presented with said customized lesson.

32. A computer readable medium storing instructions for causing a computing device to deliver a lesson to a student, said computer readable medium comprising:
a) a first group of instructions, said first group of instructions causing a pre-existing lesson to be presented to the student while permitting said student to initiate a question operation during the presentation of said lesson;
b) a second group of instructions, said second group of instructions causing said computing device to detect the initiation of a question operation by said student, causing the presentation of the lesson to be paused, and enabling a first question to be received from said student;
c) a third group of instructions, said third group of instructions, upon receiving a question from said student, causing said first question to be compared to a list of pre-existing questions and corresponding answers, causing at least one of said pre-existing questions to be selected as a potential match to said first question, causing said at least one of pre-existing questions to be presented to said student, and causing said student to be prompted to select which if any of said at least one pre-existing questions is a match to said first question;
d) a fourth group of instructions, said fourth group of instructions, upon receiving input from said student identifying a second question from said at least one of said pre-existing questions as a match to said first question, causing a corresponding pre-existing answer to said second question to be presented to said student, and causing said student to be prompted to indicate if said pre-existing answer is satisfactory to said student; and
e) a fifth group of instructions, said fifth group of instructions, upon receiving input from said student indicating none of said at least one of said pre-existing questions are a match to said first question, causing said first question to be submitted to an instructor.
